(19) United States
(12) Patent Application Publication
(10) Pub. No.: US 2026/0352526 A1
(43) Pub. Date: Nov. 5, 2026

(54) THZ CRYO-CMOS Backscatter Transceiver: A Contactless 4 Kelvin-300 Kelvin Data Interface

(71) Applicant: Massachusetts Institute of Technology, Cambridge, MA (US)

(72) Inventors: Ruonan HAN, Winchester, MA (US); Jinchen WANG, Cambridge, MA (US)

(21) Appl. No.: 18/440,524

(22) Filed: Feb. 13, 2024

Related U.S. Application Data
(60) Provisional application No. 63/485,918, filed on Feb. 19, 2023.
(60) Provisional application No. 63/486,969, filed on Feb. 25, 2023.

(51) Int. Cl. H04L 27/00; H01Q 1/22; H01Q 9/04; H01Q 13/02; H01Q 21/06; H04B 10/90; H04L 27/12; H04L 27/20

(52) U.S. Cl. CPC H04L 27/0008; H01Q 1/2283; H01Q 9/0407; H01Q 13/02; H01Q 21/065; H04B 10/90; H04L 27/12; H04L 27/206

(57) ABSTRACT

A terahertz (THz) transceiver chip operating at 4K as a CMOS-based, fully-integrable interconnect solution is disclosed. The carrier frequency may be between 10GHz and 10THz, which includes both the millimeter wave (MMW) band and the terahertz (THz) band. The transceiver avoids power-hungry terahertz (THz) generation by adopting a passive backscatter communication scheme. A4Gbps uplink is demonstrated with only 176fJ/b added heat load. In the downlink, the heat load is further reduced to 34fJ/b at 4.4Gbps. This fully contactless 4K-RT interface may be used to deliver digitized control/readout data, and optionally some analog/RF signals, such as low phase noise clocks.

This application claims priority to U.S. Provisional Patent Application Serial No. 63/485,918, filed Feb. 19, 2023, and U.S. Provisional Patent Application Serial No. 63/486,969, filed Feb. 25, 2023, the disclosures of which are incorporated herein by reference in their entireties.

This invention was made with government support under OAC1839159 awarded by the National Science Foundation. The government has certain rights in the invention.

### BACKGROUND

Modern low-temperature large-scale systems, such as high-sensitivity IR/THz imaging arrays and quantum computers, require massive signal connections between the cooled system core and external room-temperature (RT) components. An error-protected quantum computer needs thousands or even millions of qubits operating at cryogenic temperature. Despite the rapid development of highly-integrated quantum processors, future scalability may still be largely limited by the cables connecting the processors and peripheral control/processing units. This is because, even using low-thermal-conductivity metal materials, such as is shown in FIG. 1, those cables still transport non-negligible amount of heat due to the large temperature gradient. In a dilution refrigerator, a stainless-steel UT-085-SS-SS cable could pose close to one mW of heat load to the 4K stage, and tens of mW to the 50K stage. To drive such a non-copper cable in the cryogenic-to-RT (i.e., uplink) data path, standard I/O circuits in cooled sensors/processors typically consume pJ/b-level energy, further raising the overall heat load. Recently, optical fibers along with cryogenic InGaAs photodiode and VCSEL lasers are used for <20mK coherent qubit control/readout mode and 4K-to-300K uplink data mode, respectively. Using the VCSEL lasers, the energy consumption reduces to 406.2fJ/b at 10Gbps and <10⁻¹² bit-error-rate (BER).

However, this level of power consumption is still greater than desired. Thus, a system that can address these challenges would be beneficial.

### SUMMARY

A terahertz (THz) transceiver chip operating at 4K as a CMOS-based, fully-integrable interconnect solution is disclosed. The carrier frequency may be between 10GHz and 10THz, which includes both the millimeter wave (MMW) band and the terahertz (THz) band. The transceiver avoids power-hungry terahertz (THz) generation by adopting a passive backscatter communication scheme. A 4Gbps uplink is demonstrated with only 176fJ/b added heat load. In the downlink, the heat load is further reduced to 34fJ/b at 4.4Gbps. This fully contactless 4K-RT interface may be used to deliver digitized control/readout data, and optionally some analog/RF signals, such as low phase noise clocks.

According to one embodiment, a system is disclosed. The system comprises a room temperature system, comprising a transceiver; and a cryogenic system maintained at less than 10K, comprising a cryo-CMOS chip, wherein the cryo-CMOS chip comprises a THz antenna; and a differential THz detector; wherein the transceiver wirelessly transmits signals to the cryo-CMOS chip to transfer data between the room temperature system and the cryogenic system. In some embodiments, the transceiver utilizes a carrier frequency of between 10GHz and 10THz. In some embodiments, data is transmitted at a data rate of between 100Mbps and 40Gbps. In some embodiments, the system includes a horn antenna disposed between the transceiver and the cryo-CMOS chip without physical contact. In some embodiments, a backscatter communication link is used to uplink data from the cryogenic system to the room temperature system. In certain embodiments, the THz antenna comprises at least two patch antennas, each having an output, a feed port opposite the output and two sides, wherein the feed port is in communication with each side through a respective transmission line and a respective switch.

In certain embodiments, the cryo-CMOS chip supports two modulation modes for uplink communications. In certain embodiments, the two modulation modes comprise on-off keying (OOK) and binary phase-shift keying (BPSK). In certain embodiments, in OOK mode, one switch is always open and a second switch is modulated based on a state of a data bit to be transmitted, such that a reflected wave is either orthogonal to a transmitted wave or has a same transverse magnetic mode as the transmitted wave. In certain embodiments, in BPSK mode, both switches are modulated based on a state of a data bit to the transmitted, such that a reflected wave is orthogonal to a transmitted wave and a phase of the reflected wave is determined based on the state of the data bit. In some embodiments, the transceiver utilizes a carrier frequency and wherein each transmission line has a length equal to one wavelength of the carrier frequency. In some embodiments, the THz antenna comprises a Nx2 quad-feed patch antenna array, wherein a first set of N patch antennas are AC coupled to a positive input of the differential THz detector; and a second set of N patch antennas are AC coupled to a negative input of the differential THz detector. In some embodiments, the THz antenna comprises a 2×2 quad-feed patch antenna array. In some embodiments, each patch antenna has a square shape, leading to an identical resonance frequency for waves polarized in either TM₀₁₀ or TM₁₀₀transverse magnetic modes. In some embodiments, the differential THz detector comprises a square-law detector, and an output of the differential THz detector comprises a current; wherein the current is supplied to a transimpedance amplifier to convert the current to a voltage, and the voltage is then amplified using a voltage amplifier. In some embodiments, the system utilizes OOK for downlink communications. In some embodiments, the system achieves a downlink rate of 4.4Gbps with downlink power of 149 µW. In some embodiments, the transceiver does not use a photonic or metal cable link. In some embodiments, the cryogenic system comprises a quantum computer.

According to another embodiment, a cryo-CMOS THz transceiver chip is disclosed. The THz transceiver chip comprises a THz antenna; and a differential THz detector; wherein the THz antenna comprises a Nx2 quad-feed patch antenna array, wherein a first set of N patch antennas are AC coupled to a positive input of the differential THz detector; and a second set of N patch antennas are AC coupled to a negative input of the differential THz detector; and wherein each patch antenna comprises an output, a feed port opposite the output and two sides, wherein the feed port is in communication with each side through a respective transmission line and a respective switch.

### BRIEF DESCRIPTION OF THE DRAWINGS

For a better understanding of the present disclosure, reference is made to the accompanying drawings, in which like elements are referenced with like numerals, and in which:

FIG. 1 shows a conventional technique for transferring information from the room temperature (RT) computer to a low temperature (4K) system;

FIG. 2 shows the architecture of the contactless information link according to the present disclosure;

FIG. 3 shows the architecture of the 4K transceiver chip;

FIG. 4 shows the antenna element in more detail;

FIGS. 5A-5C show the antenna element in each mode of operation;

FIG. 6 shows dynamic power and insertion loss as a function of gate width;

FIG. 7 shows the differential THz detector;

FIGS. 8A-8B show various parameters associated with the differential THz detector as a function of frequency;

FIG. 9A shows one topology of the read output circuit;

FIG. 9B shows the gain of the transimpedance amplifier as a function of frequency and temperature;

FIG. 10 shows the layout of the cryo-CMOS chip according to one embodiment;

FIGS. 11A-11C show various parameters related to the uplink based on one experiment; and

FIGS. 12A-12C show various parameters related to the downlink based on one experiment.

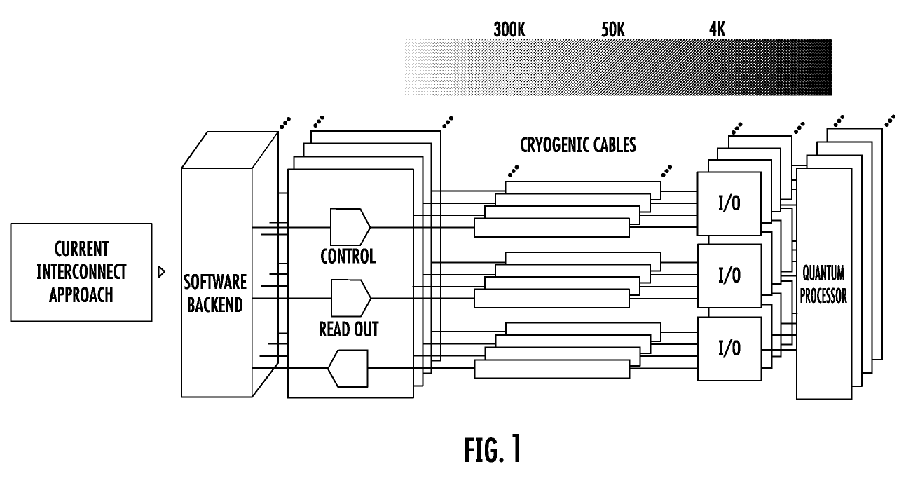

### DETAILED DESCRIPTION

A terahertz (THz) transceiver chip operating at 4K as a CMOS-based, fully-integrable interconnect solution is disclosed. The carrier frequency may be between 10GHz and 10THz, which includes both the millimeter wave (MMW) band and the terahertz (THz) band. Thus, in this disclosure, the term “THz transceiver” is meant to encompass a transceiver operating in either the MMW or THz band.

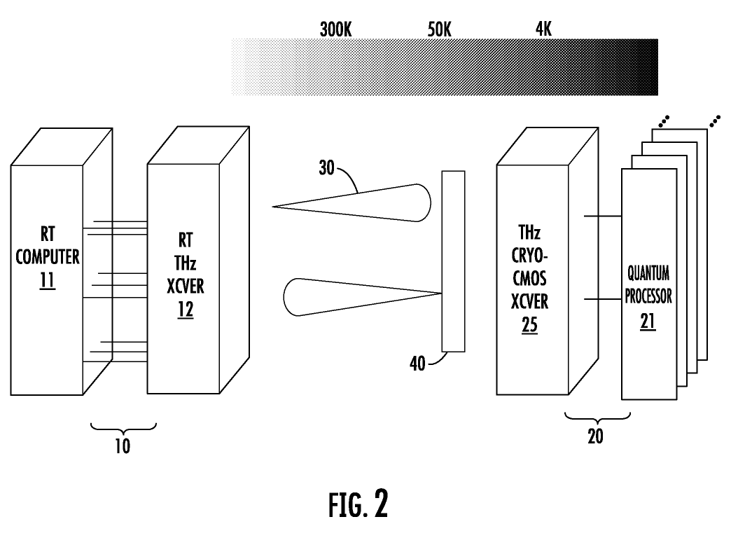

As shown in FIG. 2, this link with the RT system 10 and the cryogenic system 20 is contactless, and relies on the wireless transmission of high frequency signals 30 between the RT system 10 and the cryogenic system 20. The RT system 10 includes one or more RT computers 11 and a room temperature (RT) THz transceiver 12. Note that while the system utilizes a room temperature system, it is understood that the RT system 10 may be disposed in an environment having any temperature. For example, the RT system 10 may be cooled below 300K, such as to 200K or lower. The cryogenic system 20 may include a quantum computer 21. This quantum computer 21 may be configured for large scale quantum computing. In some embodiments, the quantum computer may comprise at least 100 qubits. In other embodiments, the quantum computer may comprise at least 500, 1000, 10,000, 100,000 or one million qubits. The cryogenic system 20 also includes a THz transceiver chip 25. The THz transceiver chip 25 is also referred to as a cryo-CMOS chip, since it operates at cryogenic temperatures. The term “cryogenic” is meant to indicate any temperature below about 10K.

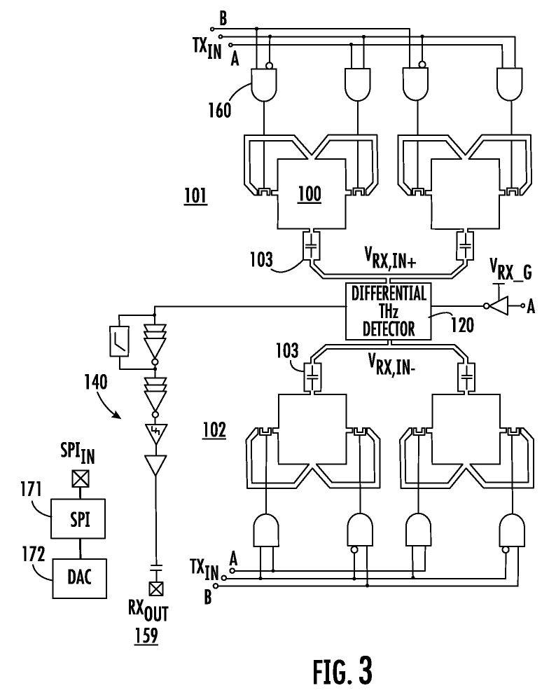

The architecture of the THz transceiver chip 25 is shown in FIG. 3. The THz transceiver chip 25 includes a plurality of antenna elements 100. A first set 101 of these antenna elements 100 is used to receive and transmit the positive polarity of the THz signal while a second set 102 of these antenna elements 100 is used to receive and transmit the negative polarity of the THz signal.

While FIG. 3 shows 4 antenna elements 100, arranged as 2 sets of two antenna elements 100 (i.e. a 2 x 2 array), it is understood that the number of antenna elements 100 is not limited by this disclosure. For example, the first set 101 may include one or more antenna elements 100, while the second set 102 has an equal number of antenna elements as the first set 101. The outputs from the first set 101 of antenna elements 100 are AC coupled together, via a coupling capacitor 103 disposed at the output of each antenna element 100 in the first set 101. Similarly, the outputs from the second set 102 of antenna elements 100 are AC coupled together, via a coupling capacitor 103 disposed at the output of each antenna element 100 in the second set 102. While the number of antenna elements 100 in each set is not limited, it is understood that more antenna elements will result in stronger received signals while also increasing power consumption.

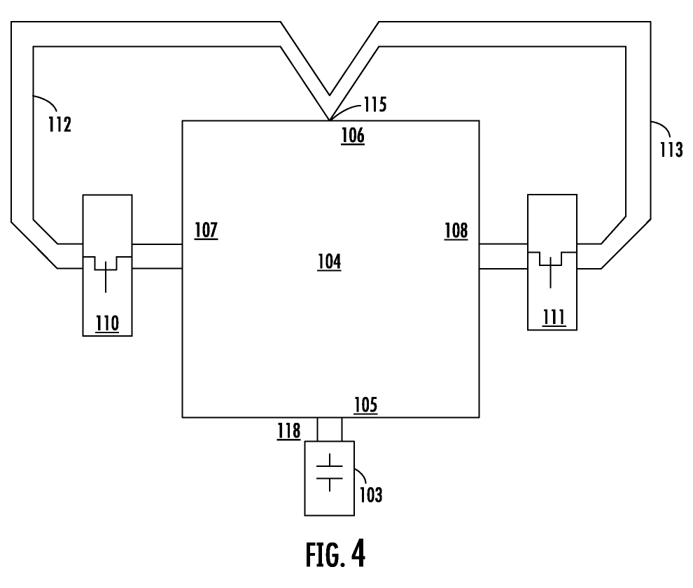

Each antenna element 100 may include a square patch antenna 104. The square shape ensures equal frequency response regardless of polarity of the incoming signal. The dimension of the square patch antenna 104 determines its resonant frequency. The dimension may be selected based on the desired carrier frequency. As noted above, this carrier frequency may be between 10GHz and 10THz. In some embodiments, the carrier frequency may be between 100GHz and 1THz. The patch antennas 104 may be constructed from copper, and may be the top layer of the THz transceiver chip 25. The middle of each of the four sides of the square patch antenna 104 is connected to at least one other component, as best shown in FIG. 4. One side 105 is used to generate the output 118, and the middle of this side 105 is in communication with a respective coupling capacitor 103. The side 106 opposite the output 118 is used to provide the feed port 115 to the square patch antenna 104. Specifically, the two sides 107, 108 are each in communication with a respective switch 110, 111. These switches 110, 111 may be field effect transistors (FETs), and more specifically, may be FinFETs. Each switch 110, 111 is in communication with a respective transmission line 112, 113. The length of the path from feed port 115 through transmission line 112 and switch 110 to the side 107 is designed to be roughly 1 wavelength of the carrier frequency. Likewise, the length of the path from feed port 115 through transmission line 113 and switch 111 to the side 108 is also designed to be roughly 1 wavelength of the carrier frequency. Thus, signals received by the patch antenna 104 are captured at feed port 115 and are used as inputs to inject back into one of the sides 107, 108 of the patch antenna 104 during the uplink mode.

Returning to FIG. 3, the switches 110, 111 are controlled using control logic 160. Specifically, in some embodiments, the control logic 160 utilizes two control signals, labelled A and B and one data signal, labelled Tx. Control signal A is used to select whether the THz transceiver chip 25 is being used to receive data or transmit data. When transmitting, control signal B is used to determine the type of modulation used, binary phase-switch keying (BPSK) or on-off keying (OOK). Each is described in more detail below.

As noted above, the outputs 118 of all of the antenna elements 100 in the first set 101 are AC coupled together using coupling capacitors 103 and enter a differential THz detector 120, as the positive polarity. The outputs 118 of all of the antenna elements 100 in the second set 102 are AC coupled together using coupling capacitors 103 and enter the differential THz detector 120, as the negative polarity. The design of the differential THz detector 120 is described in more detail below.

The output from the differential THz detector 120 enters the read output circuit 140, which generates the received signal 159. The read output circuit 140 is described in more detail below.

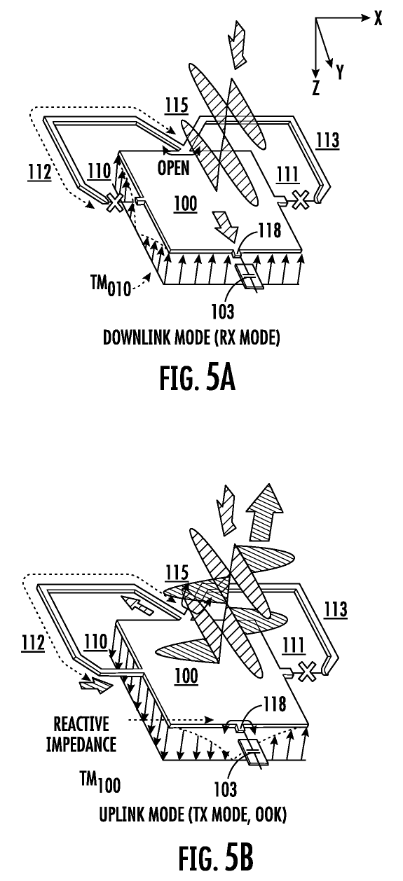

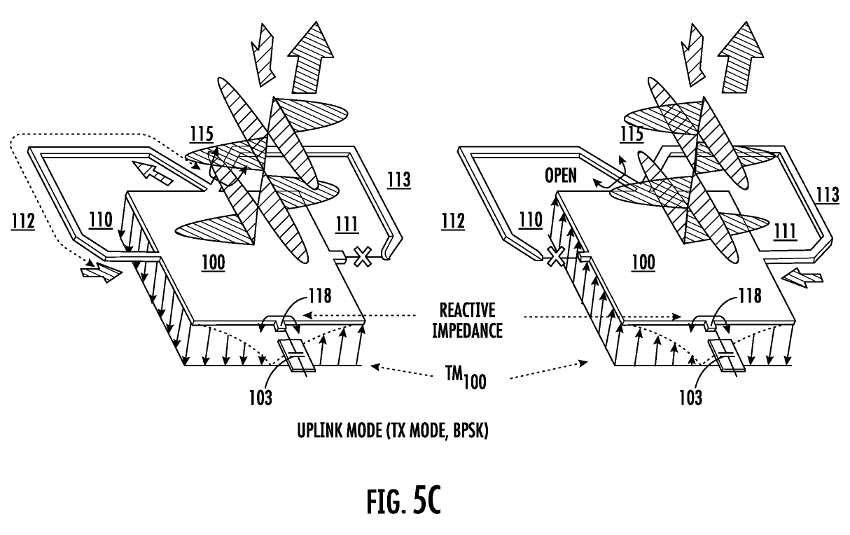

FIG. 5A shows the operation of the antenna element 100 in downlink mode. In this mode, the switches 110, 111 are both open, such that there is no connection from the feed port 115 back to the antenna element 100. Any received signal is transmitted through the output 118 and through the coupling capacitor 103.

FIGS. 5B-5C show the operation of the antenna element in uplink mode. Note that, to conserve power, the antenna elements operate using backscatter. In this mode, a carrier signal is transmitted from the RT THz transceiver 12 to the THz transceiver chip 25. That signal is modulated by the THz transceiver chip 25 and reflected back toward the RT system 10.

As noted above, there are two different modulation schemes that may be used for the uplink. In the uplink mode, the differential THz detector 120 is deactivated and presents a reactive impedance that reflects any antenna-received wave back. FIG. 5B shows the on-off keying modulation. In this mode, one of the switches 110, 111 is always open. In this state, the disconnected switch and associated transmission line present open to the top edge of the patch antenna 104, hence avoiding disturbance to the backscatter process. The other switch 110, 111 is controlled based on the data to be transmitted (Tx). For example, in one embodiment, if Tx=0, then both switches 110, 111 are open and the polarization of the reflected signal is unchanged. However, if Tx=1, then the switch closes, causing the reflected signal to be orthogonal to the received signal. Thus, if the incoming signal was transmitted using transverse magnetic (TM) mode TM₀₁₀, the reflected signal would be TM₁₀₀. Note that FIG. 5B shows that the reflected signal is orthogonal to the incoming signal when a data bit of 1 is being transmitted. Thus, in OOK mode, the reflected signal is either the same as the transmitted signal, or rotated 90°.

FIG. 5C shows the second modulation scheme that may be used for the uplink. The two figures represent the configuration of the antenna element 100 and the reflected signal for the two states of the transmitted data bit (Tx). In this mode, one of the switches 110, 111 is closed when the data to be transmitted is 1 (Tx=1), while the other of the switches 110, 111 is closed when the data to be transmitted is 0 (Tx=0). Thus, in this mode, one switch is closed and one switch is open at all times. Thus, the received signal is collected at the feed port 115 and either injected on the left side 107 of the patch antenna 104, via transmission line 112 and switch 110 or is injected on the right side 108 via transmission line 113 and switch 111. The open switch presents as open to the feed port 115, hence avoiding disturbance to the backscatter process. Thus, as shown in the figure, the reflected signal is always orthogonal to the received signal; however, the phase of the reflected signal differs by 180°, based on the state of the bit to be transmitted. In other words, if the incoming signal has transverse magnetic state TM₀₁₀, the reflected signal will always have transverse magnetic state TM₁₀₀. The compact antenna structure therefore realizes binary phase-shift keying (BPSK) modulation and cross polarization in the backscatter communication; the latter reduces direct leakage from the THz source to the RT THz transceiver 12. Further, the orthogonal polarization of the reflected signal avoids interference between the incident wave and the reflected wave.

Note that OOK consumes less power, but has a higher bit error rate (BER). In contrast, BPSK consumes more power but achieves lower BER at the same signal to noise ratio (SNR).

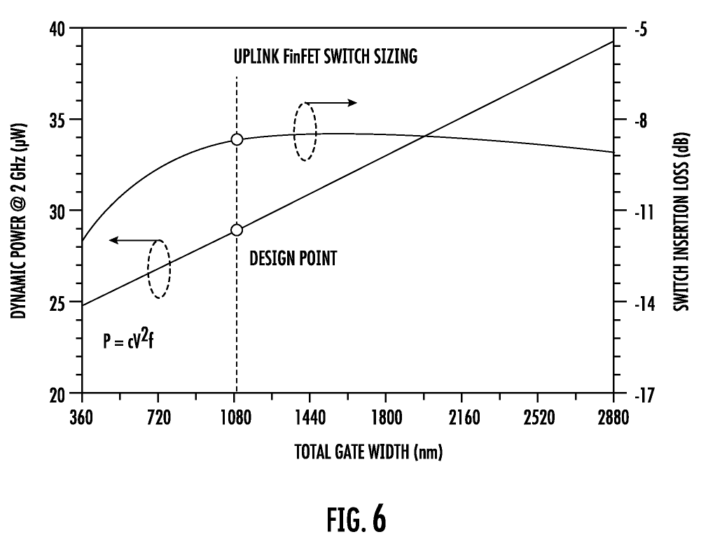

For the uplink mode, the power consumption is dominated by the dynamic power used by the switches 110, 111. Specifically, the power consumption of the uplink is dominated by the CV ² f dynamic power of the THz switches. FIG. 6 shows a graph showing power consumption and insertion loss as a function of switch width. A narrower switch reduces such power, but increases the THz power loss inside the switch. In contrast, a wider switch consumes more power but introduces less insertion loss. In one particular embodiment, based on the simulated data in FIG. 6, the width of switches 110, 111 is set to 1.08µm.

Additionally, to realize broadband matching between the transmission lines 112, 113 and the respective switches 110, 111, a stepped impedance structure may be used for the transmission lines 112, 113.

Additionally, it is noted that the link budget of backscatter communication is proportional to the square of antenna radiation efficiency η, which is only 38% at 300K. Fortunately, with the large electrical conductivity increase of copper at 4K, the simulated η improves to 97%.

Further, to achieve a larger radiation aperture and to avoid out-of-aperture THz power injection into the cryostat, a custom-designed horn antenna 40 with a large flange shield may be utilized. This may be implemented using 3D metal printing and placed at the 60K stage in front of the THz transceiver chip 25 without physical contact (see FIG. 2). The use of the horn antenna 40 may result in an overall gain of roughly 20dBi.

In operation, the carrier frequency may be between 10GHz and 10THz. In some embodiments, the carrier frequency may be between 100GHz and 1THz. The data rate may be between 100Mbps and 40Gbps. Note that the data rate for the uplink mode may differ from the data rate for the downlink mode.

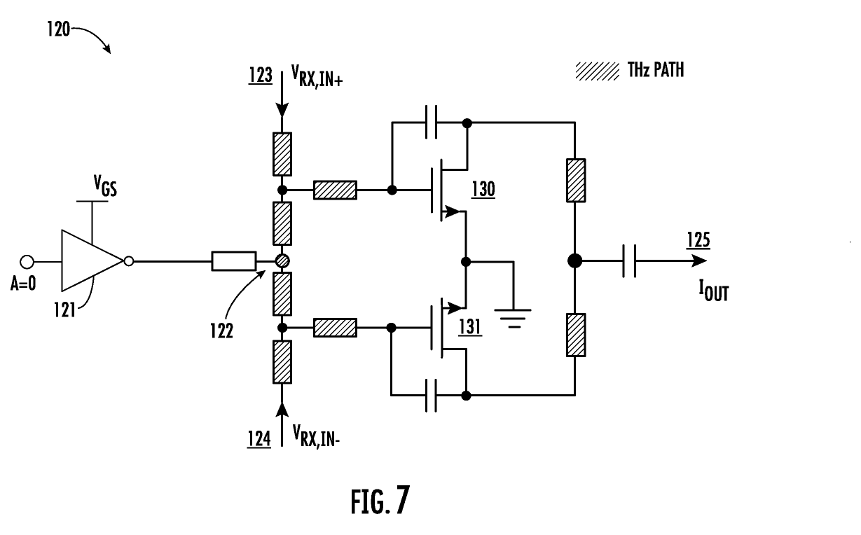

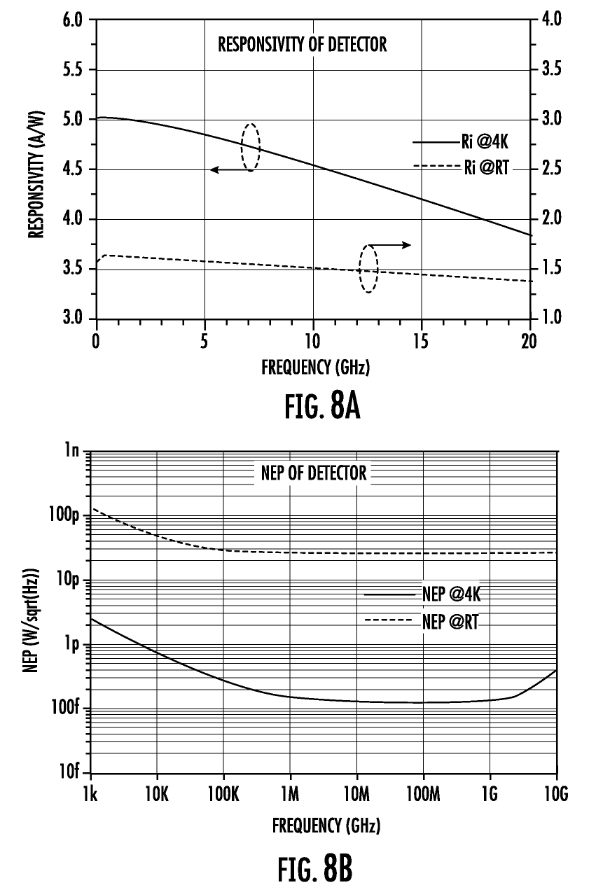

FIG. 7 shows the topology of the differential THz detector 120. As noted above, the control signal A determines the direction of the link. Thus, when A=0, the differential THz detector 120 is activated. This is achieved by applying a gate bias voltage V_{gs} to transistors 130, 131 using inverter 121. The differential THz detector 120 is configured as a THz square-law detector, as is known in the art. Exciting the TM₀₁₀ mode of the antenna elements 100, the incident wave is injected differentially into the differential THz detector 120. As shown in FIGS. 8A and 8B, respectively, based on a cold-FET detector topology, the detector at 4K achieves ~4.5A/W current responsivity and ~0.13pW/Hz^{1/2} noise equivalent power (NEP) in the simulation while consuming zero power. The faster device response, lower thermal noise and higher antenna efficiency lead to a ~500x sensitivity increase compared to that operating at 300K. In FIG. 7, the detector bias node 122 is a virtual ground created by the differential THz input signal, which prevents the impact of parasitics at that node of the differential THz detector 120.

The outputs 118 from the first set 101 enter the differential THz detector 120 at positive input 123, while the outputs 118 from the second set 102 enter at negative input 124. Note that these two inputs are voltages. The output 125 of the differential THz detector 120 is a current which is representative of the square of the difference between the positive input 123 and the negative input 124.

The outputs 118 of the antenna elements 100 are configured to received signals in the TM₀₁₀mode, but not to receive signals in the TM₁₀₀mode. Thus, in certain embodiments, the downlink carrier frequency is OOK modulated. In this way, the received wave is either present in the TM₀₁₀ mode or absent. This simplifies the demodulation of the received signal.

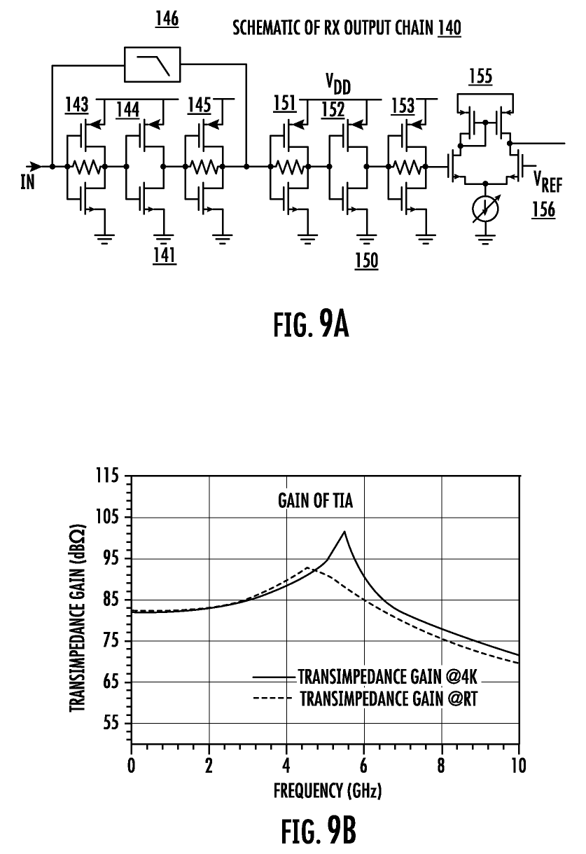

The output 125 from the differential THz detector 120 then enters a read output circuit 140. This circuit is shown in FIG. 9A. The read output circuit 140 comprises a transimpedance amplifier 141 to convert the output current into a voltage and a comparator 155. The transimpedance amplifier (TIA) 141 achieves a gain of roughly 80 dbΩ. The TIA 141 comprises three inverters 143, 144, 145, wherein the first and last inverters are operating in their linear regions. These inverters are in parallel with a low pass filter 146. The read output circuit 140 also comprises a voltage amplifier 150, which also comprises three inverters 151, 152, 153, wherein the first and last inverters are operating in their linear regions. The comparator 155 receives the final output from voltage amplifier 150 (which is an analog voltage). This analog voltage is compared to a reference voltage 156 which serves to digitize the signal. Note that this is one implementation of a read output circuit 140; and other implementations are also possible. The gain of the TIA 141 as a function of frequency is shown in FIG. 9B. The frequency is typically ½ of the data rate, when using OOK modulation.

Returning to FIG. 3, the THz transceiver chip 25 may also include a Serial Peripheral Interface (SPI) chip 171 which is used to receive a serial input (SPI_{IN}) and convert it to parallel data, such as a data byte or word. That parallel data is then provided as the input to a Digital to Analog Converter (DAC) 172, which converts the parallel digital data into an analog voltage. That analog voltage may be the reference voltage 156 used as an input to comparator 156 (see FIG. 9A). This analog voltage may also be used to establish the reference for control signals A and B. In other embodiments, the SPI chip 171 may not be present; rather the DAC 172 may accept a serial input. In yet another embodiment, the input to the THz transceiver chip 25 may be in the form of parallel data and the SPI chip 171 may not be needed. Thus, this section of the THz transceiver chip 25 shows one circuit that may be used for the creation of the analog reference voltage, but other implementations are also possible.

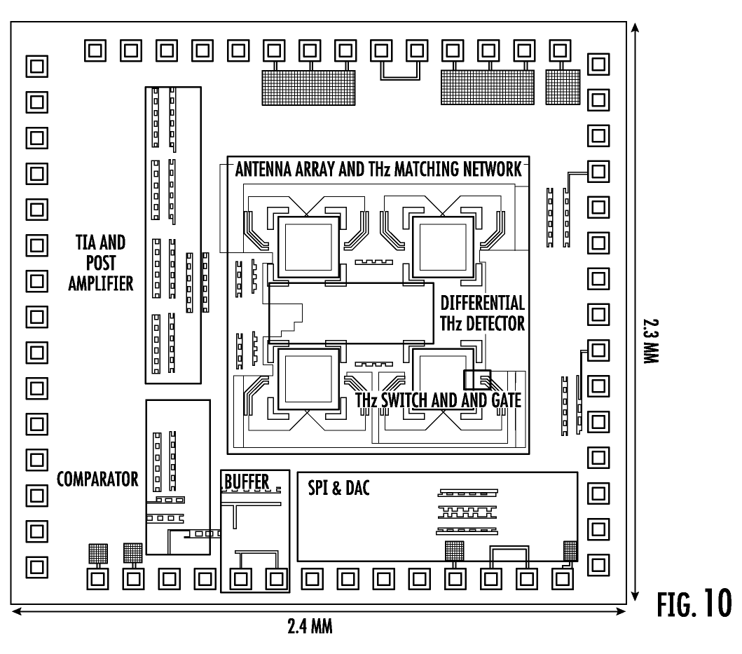

In some embodiments, the THz transceiver chip 25 is fabricated using a 22nm process and is designed using device models at 4K. One such THz transceiver chip 25 and its layout is shown in FIG. 10. In this embodiment, the die size is 5.5mm². The locations of the various components shown in FIG. 3 are labelled in FIG. 10.

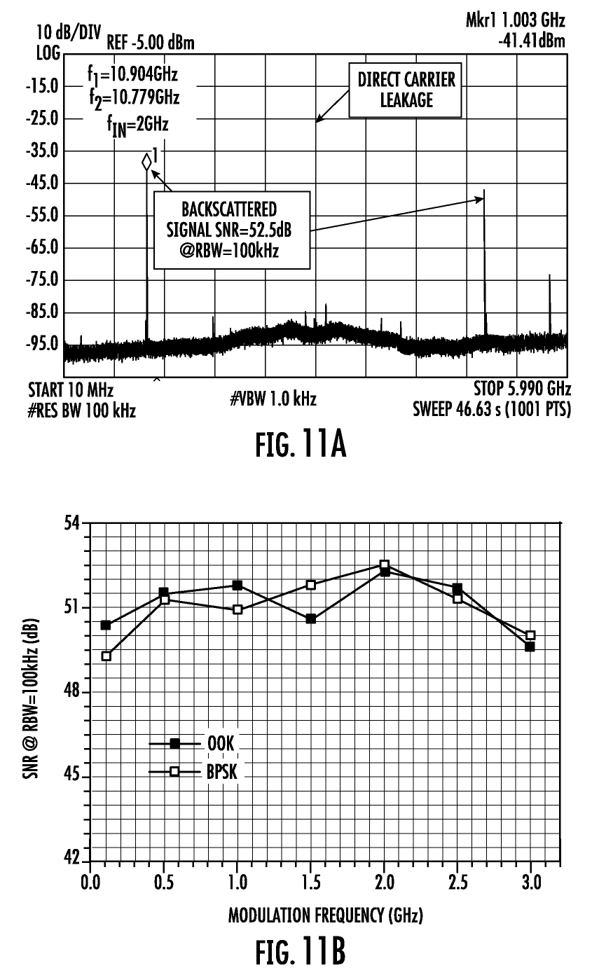

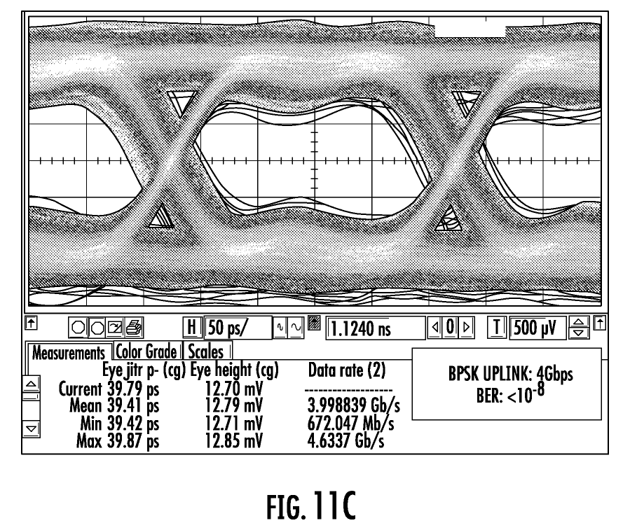

In one experiment, to verify the operation and power consumption of the THz transceiver chip 25, the chip is mounted to a round PCB with a diameter of 28mm, which is then mounted to the 4K cold-finger of a cryostat. The THz radiation is coupled into and out of the THz transceiver chip 25 through a horn antenna and the glass window of the cryostat. The setup of the uplink measurement utilized a VDI amplifier-multiplier chain (AMC-681) to generate the carrier frequency, which in this experiment was 260GHz. The setup also utilized a VDI sub-harmonic mixer to demodulate the backscattered wave. Their horn antennas are placed with orthogonal E-planes. Single-tone signal and pseudo-random binary sequence (PRBS) data are fed into the chip from an arbitrary waveform generator. FIG. 11A shows the down-converted BPSK backscatter spectrum, which gives a single-sideband SNR of 52.5dB at 100kHz resolution bandwidth (RBW) and indicates sufficient link budget for multi-Gbps transmission. FIG. 11B shows the signal to noise ratio (SNR) over various modulation frequencies, while FIG. 11C shows an eye diagram of demodulated BPSK data when a 4Gbps PRBS is fed to the chip. At 4Gbps, the OOK and BPSK modes provide <10⁻⁶ and <10⁻⁸ BER while consuming 305µW and 457µW of power, respectively. By monitoring the temperature rise of the cryostat with and without the external THz source, it was determined that the THz power injected into the cryostat is ~400µW (with ~50µW uncertainty), resulting in an overall heat load of 176fJ/b (OOK) and 214fJ/b (BPSK).

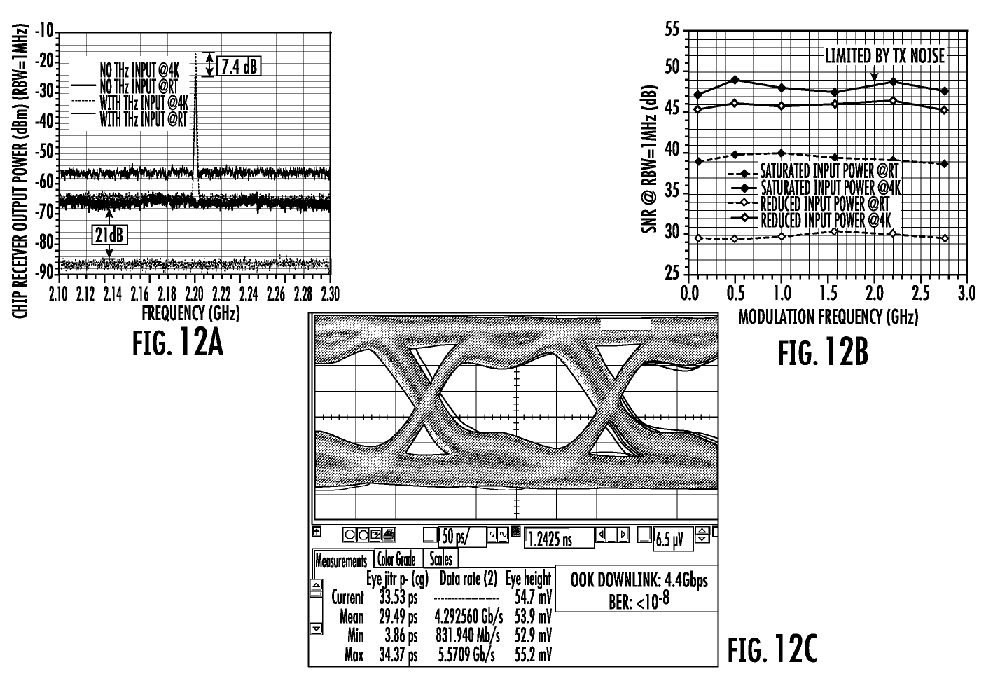

Additionally, an experiment was conducted to measure downlink performance. In the downlink measurement, reduced THz power injection (<10µW) is performed to avoid chip receiver saturation, and the ~11GHz input of the VDI-AMC is OOK modulated. First, with the VDI-AMC turned off, the measured noise floor of the chip receiver output is reduced by 21dB from RT to 4K, as shown in FIG. 12A. Then, with the VDI-AMC turned on, the chip receiver output power increases by 7.4dB from RT to 4K, as shown in FIG. 12A. These two values verify the previous estimate of 500x sensitivity improvement at 4K. With THz input, the noise floor at both temperatures is however all elevated, indicating that the SNR of the downlink (i.e. 49dB maximum at RBW=1MHz) is already limited by the noise of the VDI-AMC radiation, not the chip itself, as shown in FIG. 12B. FIG. 12C shows an eye diagram of the chip output when the AMC is driven by a 4.4Gbps PRBS and corresponds to a BER below 10⁻⁸. The downlink chip power is 149μW and the injected THz power is negligible, which leads to a heat load of 34fJ/bit.

In summary, based on experimental testing, it has been found that the uplink mode has the following characteristics when operating with a 260GHz carrier and a 4Gbps data rate. The uplink BER for OOK was 10⁻⁶, while the BER for BPSK was less than 10⁻⁸. The uplink power consumed by the THz transceiver chip 25 was 705 μW in OOK mode, with 400 μW supplied by the received wave and 857 μW in BPSK mode, again with 400 μW supplied by the received wave. This results in an uplink energy efficiency of 176 fJ/bit in the OOK mode and 214 fJ/bit for BPSK mode. Additionally, the downlink mode has the following characteristics when operating with a 260GHz carrier and a 4.4 Gbps data rate. The downlink BER is less than 10⁻⁸. The downlink power consumed by the THz transceiver chip 25 was 149 μW in OOK mode. This results in an downlink energy efficiency of 34 fJ/bit in the OOK mode.

Note that while FIG. 10 shows the THz transceiver chip 25 as comprising only the components shown in FIG. 3, it is understood that other functionality may also be included in the chip.

The present system has many advantages. The present system relies on wireless communications between the room temperature system and the cryogenic system. Consequently, no passive heat is transferred by cables connecting the two systems. Additionally, the present system utilizes backscattering as the communication link to transfer data from the cryogenic system back to the room temperature system. This significantly reduces the power consumption of the communications uplink. In some tests, the uplink energy efficiency was less than 200 fJ/b in OOK mode and less than 250 fJ/b in BPSK mode. Further, these rates were achieved with a BER of less than 10⁻⁶ and 10⁻⁸, respectively and a data rate of 4Gbps. Further, the wireless interface reduces the wiring complexity of large-scale cryogenic systems. Additionally, the cryo-CMOS chip described herein utilizes a standard CMOS process, making it relatively inexpensive to manufacture. Furthermore, as shown in FIG. 10, the cryo-CMOS chip has very small die size, allowing it to easily scale for future large scale quantum systems.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system comprising:
a room temperature system, comprising a transceiver; and
a cryogenic system maintained at less than 10K, comprising a cryo-CMOS chip, wherein the cryo-CMOS chip comprises a THz antenna; and
a differential THz detector;
wherein the transceiver wirelessly transmits signals to the cryo-CMOS chip to transfer data between the room temperature system and the cryogenic system.

2. The system of claim 1, wherein the transceiver utilizes a carrier frequency of between 10GHz and 10THz.

3. The system of claim 1, wherein data is transmitted at a data rate of between 100Mbps and 40Gbps.

4. The system of claim 1, further comprising a horn antenna disposed between the transceiver and the cryo-CMOS chip without physical contact.

5. The system of claim 1, wherein a backscatter communication link is used to uplink data from the cryogenic system to the room temperature system.

6. The system of claim 5, wherein the THz antenna comprises at least two patch antennas, each having an output, a feed port opposite the output and two sides, wherein the feed port is in communication with each side through a respective transmission line and a respective switch.

7. The system of claim 6, wherein the cryo-CMOS chip supports two modulation modes for uplink communications.

8. The system of claim 7, wherein the two modulation modes comprise on-off keying (OOK) and binary phase-shift keying (BPSK).

9. The system of claim 8, wherein in OOK mode, one switch is always open and a second switch is modulated based on a state of a data bit to be transmitted, such that a reflected wave is either orthogonal to a transmitted wave or has a same transverse magnetic mode as the transmitted wave.

10. The system of claim 8, wherein in BPSK mode, both switches are modulated based on a state of a data bit to the transmitted, such that a reflected wave is orthogonal to a transmitted wave and a phase of the reflected wave is determined based on the state of the data bit.

11. The system of claim 6, wherein the transceiver utilizes a carrier frequency and wherein each transmission line has a length equal to one wavelength of the carrier frequency.

12. The system of claim 1, wherein the THz antenna comprises a Nx2 quad-feed patch antenna array, wherein a first set of N patch antennas are AC coupled to a positive input of the differential THz detector; and a second set of N patch antennas are AC coupled to a negative input of the differential THz detector.

13. The system of claim 12, wherein the THz antenna comprises a 2×2 quad-feed patch antenna array.

14. The system of claim 12, wherein each patch antenna has a square shape, leading to an identical resonance frequency for waves polarized in either TM₀₁₀ or TM₁₀₀ transverse magnetic modes.

15. The system of claim 12, wherein the differential THz detector comprises a square-law detector, and an output of the differential THz detector comprises a current; wherein the current is supplied to a transimpedance amplifier to convert the current to a voltage, and the voltage is then amplified using a voltage amplifier.

16. The system of claim 1, wherein the system utilizes OOK for downlink communications.

17. The system of claim 16, comprising a downlink rate of 4.4Gbps with downlink power of 149 µW.

18. The system of claim 1, wherein the transceiver does not use a photonic or metal cable link.

19. The system of claim 1, wherein the cryogenic system comprises a quantum computer.

20. A cryo-CMOS THz transceiver chip, comprising:
a THz antenna; and
a differential THz detector;
wherein the THz antenna comprises a Nx2 quad-feed patch antenna array, wherein a first set of N patch antennas are AC coupled to a positive input of the differential THz detector; and a second set of N patch antennas are AC coupled to a negative input of the differential THz detector; and
wherein each patch antenna comprises an output, a feed port opposite the output and two sides, wherein the feed port is in communication with each side through a respective transmission line and a respective switch.
